(19) United States
(12) Patent Application Publication
(10) Pub. No.: US 2012/0043882 A1
(43) Pub. Date: Feb. 23, 2012

(54) IMAGE DISPLAY APPARATUS

(75) Inventor: Keiji Karube, Toride-shi (JP)

(73) Assignee: CANON KABUSHIKI KAISHA, Tokyo (JP)

(21) Appl. No.: 13/172,390

(22) Filed: Jun. 29, 2011

(30) Foreign Application Priority Data
Aug. 17, 2010 (JP) 2010-182286

(51) Int. Cl. H01J 63/06

(52) U.S. Cl. 313/507

(57) ABSTRACT

An image display apparatus includes a rear plate and a face plate. The face plate 11 includes light emitting members spaced from and facing the plurality of electron-emitting devices in an image display region and emitting light responsive to irradiation with electrons, anodes mounted on the light emitting members, partitioning members interposed between the mutually adjacent light emitting members and protruding further than the light emitting members toward the rear plate, first resistance members each located in a portion of the partitioning members and spaced from and facing rear plate and electrically connected to the anodes; and second resistance members each covering a first resistance member and having a volume resistivity larger than that of the first resistance members to expose the first resistance members in the image display, wherein the partitioning member has a groove formed in the portion of the partitioning member opposing the rear plate, and the second resistance member is formed in the groove.

### BACKGROUND OF THE INVENTION

1. Field of the Invention

The present invention relates to an image display apparatus including a rear plate having a plurality of electron-emitting devices emitting electrons and a face plate having a plurality of light emitting members emitting light responsive to irradiation with electrons.

2. Description of the Related Art

Examples of the image display apparatus include an electron beam display apparatus having a plurality of electron-emitting devices emitting electrons and a plurality of light emitting members emitting light responsive to irradiation with electrons from the electron-emitting devices. In particular, an image display apparatus including a plurality of phosphors and a plurality of electron-emitting devices emitting electrons by field emission is expected to have characteristics more excellent than an image display apparatus using other methods. For example, a self-emission type image display apparatus is superior to a recent popular liquid crystal display apparatus in that no backlight is required, the angle of view is wide, fast moving images can be displayed, and the like.

The image display apparatus including a plurality of electron-emitting devices has a hermetically sealed container surrounded by a rear plate having a plurality of electron-emitting devices and a face plate having a plurality of light emitting members and anodes with the rear plate spaced from and facing the face plate. The inside of the hermetically sealed container is maintained under vacuum for electron emission. The hermetically sealed container has a spacer interposed between both plates in order to prevent deformation and break of the hermetically sealed container due to the difference in atmospheric pressure between the inside and the outside thereof.

Such an image display apparatus is disclosed in Japanese Patent Application Laid-Open No. 2010-067599. The image display apparatus disclosed in Japanese Patent Application Laid-Open No. 2010-067599 includes a plurality of ribs interposed between light emitting members of different light colors on a face plate (light-emitting substrate) to suppress halation. Further, the face plate includes a plurality of anodes (conductors) each covering at least one light emitting member and spaced apart from each other and arranged in matrix; and a plurality of resistance members (power supplying resistors) electrically connecting the plurality of anodes. Each resistance member is located on a rib. Each resistance member has a cover member covering the resistance member and the cover member has a resistance higher than that of the resistance member. Thus, even if a high voltage is applied to between the face plate and the rear plate (electron source substrate), the configuration disclosed in Japanese Patent Application Laid-Open No. 2010-067599 is described to be able to suppress discharge current to achieve high discharge resistance.

Unfortunately, in the configuration disclosed in Japanese Patent Application Laid-Open No. 2010-067599, a resistance member as a conductive member exposed from a corresponding cover member and a cover member may be scattered due to electrical load by a voltage for emitting electrons, contacting the spacer between the plates, and physical pressure applied at print process. A conductive member scattered and fallen on an electron-emitting device may cause a short-circuit between a cathode and a gate for applying a predetermined voltage to the electron-emitting device. A short circuit occurring between the cathode and the gate prevents the predetermined voltage from being applied to the electron-emitting device in the short-circuit portion, thus causing a dark point defect in the image display apparatus. Japanese Patent Application Laid-Open No. 2010-067599 does not consider that particle scattering on the face plate side may affect the rear plate side.

It is an object of the present invention to provide an image display apparatus capable of suppressing a short-circuit between a cathode and a gate for applying a predetermined voltage to an electron-emitting device.

### SUMMARY OF THE INVENTION

In order to achieve the above object, according to one aspect of the present invention, an image display apparatus comprises; a rear plate provided with a plurality of electron-emitting devices emitting an electron, a face plate arranged in opposition to the rear plate, wherein the face plate is provided with a plurality of light emitting members being arranged within an image display region displaying an image and emitting light responsive to an irradiation with the electron, an anode arranged over the light emitting member, a partitioning member arranged between the light emitting members adjacent to each other and being shaped protruding toward the rear plate beyond the light emitting member, and a first resistance member being arranged on a portion of the partitioning member opposing the rear plate and being electrically connected to the anode, and wherein the image display apparatus further comprises a second resistance member covering the first resistance member so that the first resistance member is not exposed within the image display region, and a volume resistivity of the second resistance member is larger than a volume resistivity of the first resistance member, wherein the partitioning member has a groove formed in the portion of the partitioning member opposing the rear plate, and the second resistance member is formed in the groove 25.

In the present invention, a second resistance member covering a first resistance member at least in an image display region can prevent falling and scattering of a resistance member to suppress a short-circuit between a cathode and a gate for applying a predetermined voltage to the electron-emitting device. Further, a second resistance member covering a first resistance member fallen and scattered on an electron-emitting device does not prevent the possibility of reducing the short-circuit because the second resistance member has a volume resistivity larger than that of the first resistance member.

Further features of the present invention will become apparent from the following description of exemplary embodiments with reference to the attached drawings.

### BRIEF DESCRIPTION OF THE DRAWINGS

FIG. 1 is a partially cut-out perspective view of an image display apparatus.

FIG. 2 is a plan view of a face plate and a rear plate forming the image display apparatus.

FIG. 3 is a sectional view of an image display apparatus according to a first example along line A-A′ of FIG. 1.

FIG. 4 is a sectional view of the same image display apparatus as illustrated in FIG. 3, along line B-B′ of FIG. 1.

FIG. 5 is a sectional view of an image display apparatus according to another example along line A-A′ of FIG. 1.

FIG. 6 is a sectional view of the same image display apparatus as illustrated in FIG. 5, along line B-B′ of FIG. 1.

### DESCRIPTION OF THE EMBODIMENTS

Preferred embodiments of the present invention will now be described in detail in accordance with the accompanying drawings.

The image display apparatus of the present invention can be applied to an image display apparatus including a plurality of electron-emitting devices emitting electrons and a plurality of light emitting members emitting light responsive to irradiation with electrons, for example, to a field emission display (FED) and a cathode-ray tube (CRT). Particularly, in the FED, an intense electric field occurs between the anode and the cathode, and a local high load is applied to a contact portion between the face plate and the rear plate and the spacer supporting the plates, thus increasing the possibility of scattering of a conductive member disposed in the face plate. Thus, the image display apparatus of the present invention can be applied to the FED.

Now, by taking an example of an FED, embodiments of the present invention will be described in detail using the accompanying drawings.

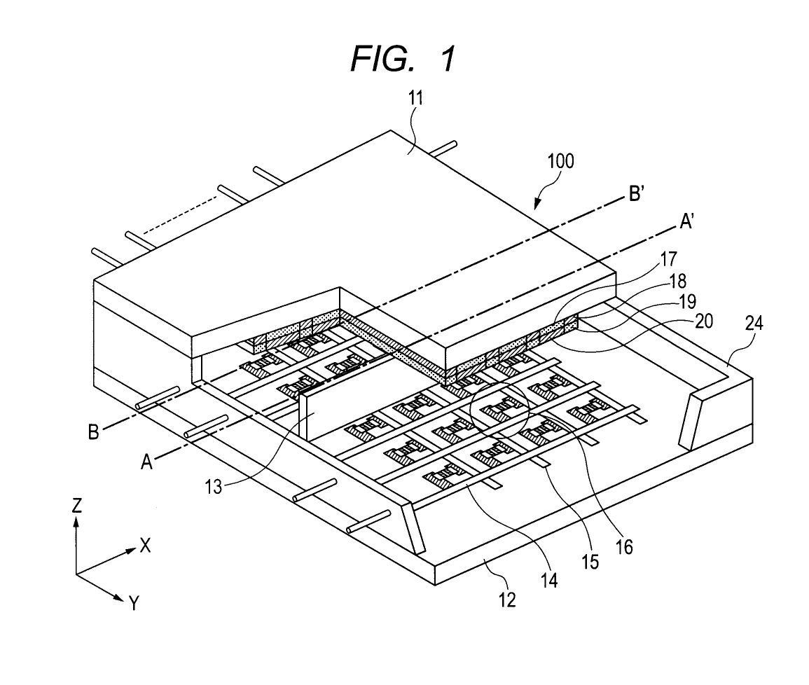

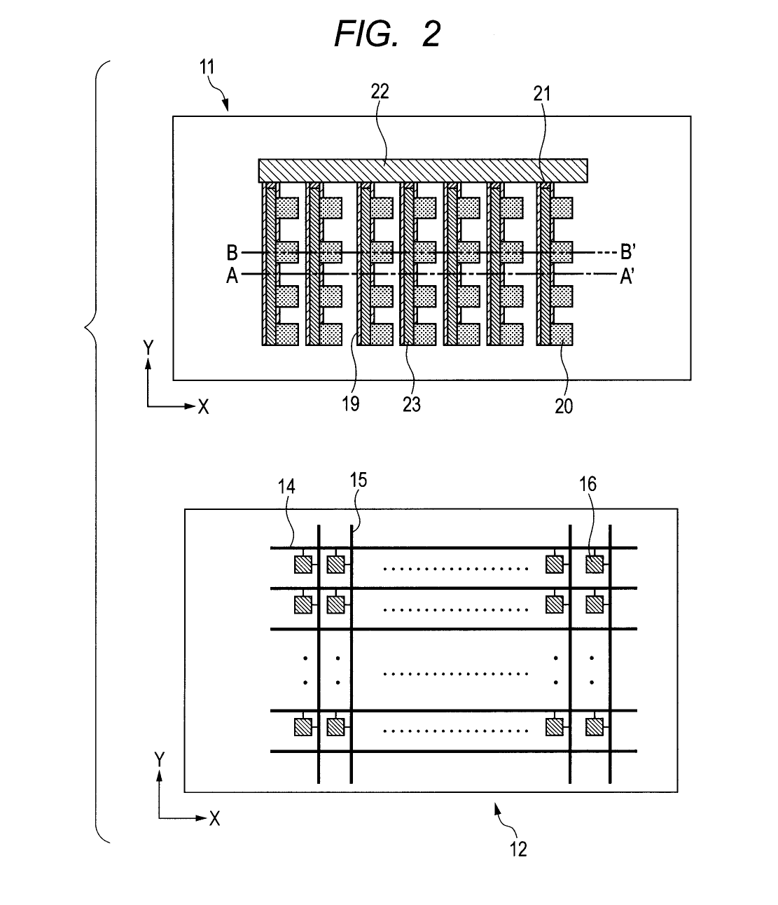

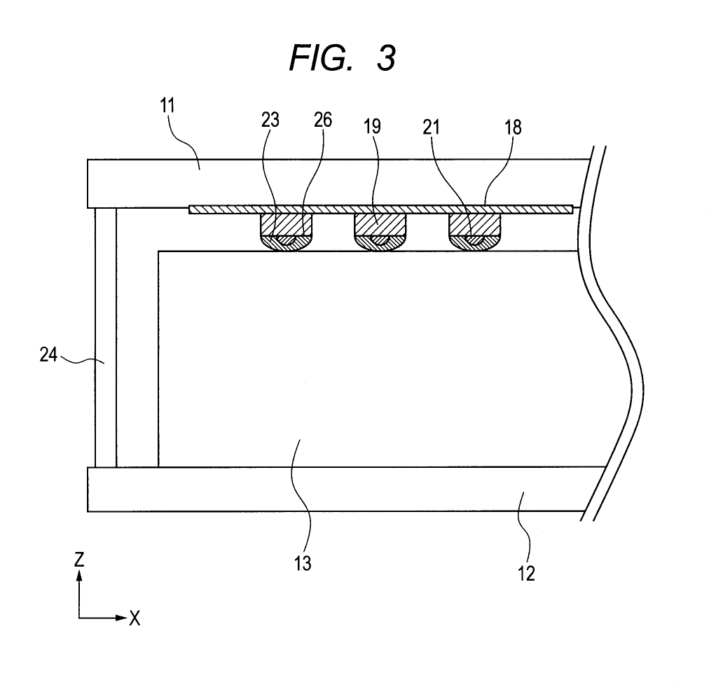

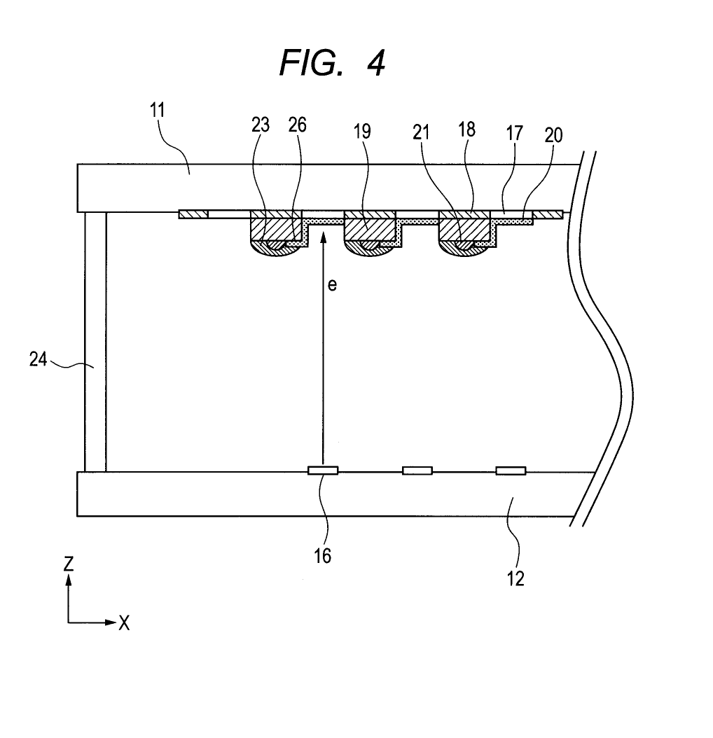

FIG. 1 illustrates an outline of an image display apparatus 100 of the present embodiment. FIG. 1 is a partially cut-out perspective view of the image display apparatus 100 in order to illustrate the internal structure thereof. FIG. 2 is a schematic view of a face plate 11 viewed from a rear plate 12 forming the image display apparatus 100 together with the face plate 11. FIG. 2 is a schematic view of the rear plate 12 viewed from the face plate 11. FIG. 3 is a sectional view along line A-A′ of FIG. 1. FIG. 4 is a sectional view along line B-B′ of FIG. 1. Note that to clarify the positions of the line A-A′ and the line B-B′ in FIG. 1, the line A-A′ and the line B-B′ are also illustrated in the respective positions in FIG. 2.

The rear plate 12 has a substrate and a plurality of electron-emitting devices 16 mounted on the substrate. In the present embodiment, as illustrated in FIG. 2, the plurality of electron-emitting devices 16 are arranged in a grid pattern. The plurality of electron-emitting devices 16 each are arranged in a matrix connected to a scanning wiring 14 as a cathode line and an information wiring 15 as a gate line.

The face plate 11 includes; a substrate, a plurality of light emitting members 17 mounted on the substrate and emitting light responsive to irradiation with electrons emitted from the plurality of electron-emitting devices 16, and a plurality of anodes 20 mounted on the plurality of light emitting members 17. The face plate 11 is spaced from and facing the rear plate 12. The plurality of light emitting members 17 are spaced from and facing the plurality of electron-emitting devices 16 in an image display region for displaying an image. Further, the face plate 11 has a plurality of partitioning members 19 each interposed between the mutually adjacent light emitting members 17 and protruding further than the light emitting members 17 toward the rear plate side. In the present embodiment, the plurality of partitioning members 19 are linearly arranged in a stripe form to partition the plurality of light emitting members 17 arranged in a grid pattern into a plurality of groups.

The portion of a top portion 24 of a partitioning member 19 facing the rear plate 12 has a first resistance member 21 electrically connected to an anode 20. In the present embodiment, a plurality of the first resistance members 21 are arranged in a stripe form electrically connecting the mutually adjacent anodes 20 in a Y direction in the drawing to each other. The first resistance members electrically connect a feeding electrode 22 located outside the image display region and the anodes 20 inside the image display region. A voltage can be applied to the anodes 20 from an external power supply to apply an intense electric field to between both plates 11 and 12.

The partitioning members 19 partitioning the light emitting members 17 prevent electrons hitting an anode 20 on a light emitting member 17 from scattering and hitting another light emitting member 17 again (halation).

As illustrated in FIGS. 1 and 3, a spacer 13 as an atmospheric-pressure-resistant support structure is interposed between the rear plate 12 and the face plate 11. The spacer 13 is arranged in a portion between the mutually adjacent light emitting members 17 so as not to affect the image displayed on the image display apparatus 100. In the present embodiment, the spacer 13 linearly extends in the X direction in the drawing.

Meanwhile, each first resistance member 21 is located at the top portion 24 of the partitioning member 19 and arranged along the partitioning members 19 so as to cross the spacer 13. FIGS. 2 and 3 illustrate a plurality of second resistance members 23 each covering a first resistance member 21 and having a volume resistivity larger than that of the first resistance member 21 so as not to expose the first resistance member 21 at least in the image display. Thus, in the crossing portion between the spacer and the partitioning member 19, the spacer (third resistance member) 13 mutually contacts the second resistance member 23.

If there is no second resistance member 23, in the crossing portion between the spacer 13 and the partitioning member 19, the spacer 13 mutually contacts the first resistance member 21. In this case, an external impact causes the crossing portion to receive not only atmospheric pressure but also a shearing force due to rubbing between the spacer 13 and the first resistance member 21. Thereby, a part of the first resistance member 21 may be scattered into particles. Further, the first resistance member 21 may be scattered by electrical load due to a voltage applied to emit electrons. The first resistance member 21 can have a volume resistivity of 0.01 to 10 (Ω·m). A part of the first resistance member 21 scattered and fallen on an electron-emitting device 16 mounted on the rear plate 12 may cause a short-circuit between the cathode and the gate.

In the present embodiment, as described hereinbefore, the second resistance members 23 at least in the image display region cover all the first resistance members 21, and the spacer 13 contacts the second resistance members 23, thereby suppressing falling and scattering of the first resistance members 21. Further, a second resistance member 23 fallen and scattered on an electron-emitting device 16 does not prevent the effect of suppressing the possibility of causing short circuit between the cathode and the gate because the second resistance member 23 has a volume resistivity larger than that of the first resistance member 21 and has an insulating property. In order to exert the effect, the second resistance members 23 need to have a volume resistivity large enough to prevent electrical short circuit from occurring even if a second resistance member 23 falls and scatters on an electron-emitting device 16 on the rear plate 12. More specifically, each second resistance member 23 can have a volume resistivity of 1 M (Ω·m) or more.

Note that the second resistance members 23 may cover not only the first resistance members 21 inside the image display region but also the first resistance members 21 outside the image display region, and may cover at least part of the feeding electrode 22.

Further, the second resistance members 23 can have a structure containing a void. Thus, when a second resistance member 23 contacts the spacer 13, the structure can absorb the pressure from the spacer 13 to relax local stress concentration in the crossing portion between the second resistance member 23 and the spacer 13. Particularly, when the plurality of partitioning members 19 vary in height, the stress is focused on a second resistance member 23 on a higher partitioning member 19 or the spacer 13 contacting the second resistance member 23. Even in that case, the structure can prevent deformation and break of the spacer 13 and the partitioning member 19.

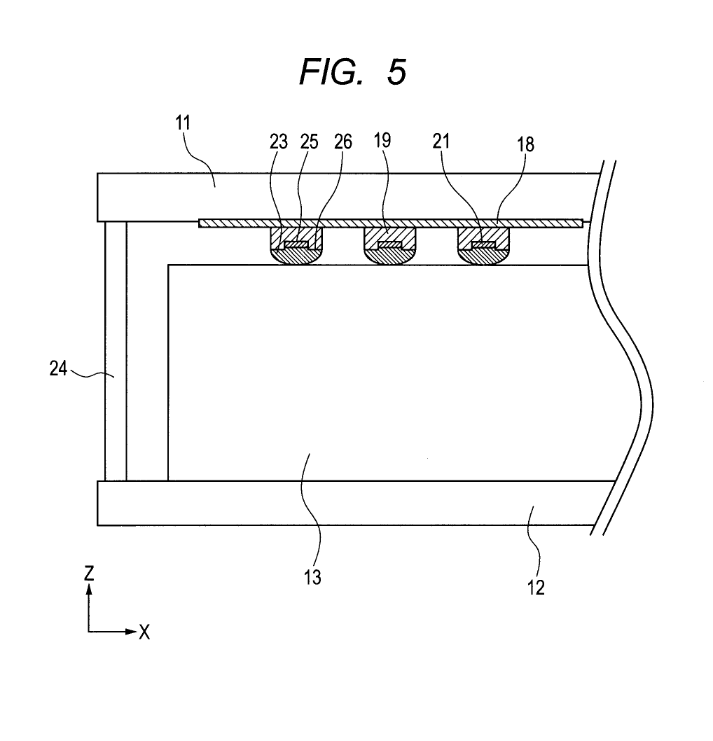

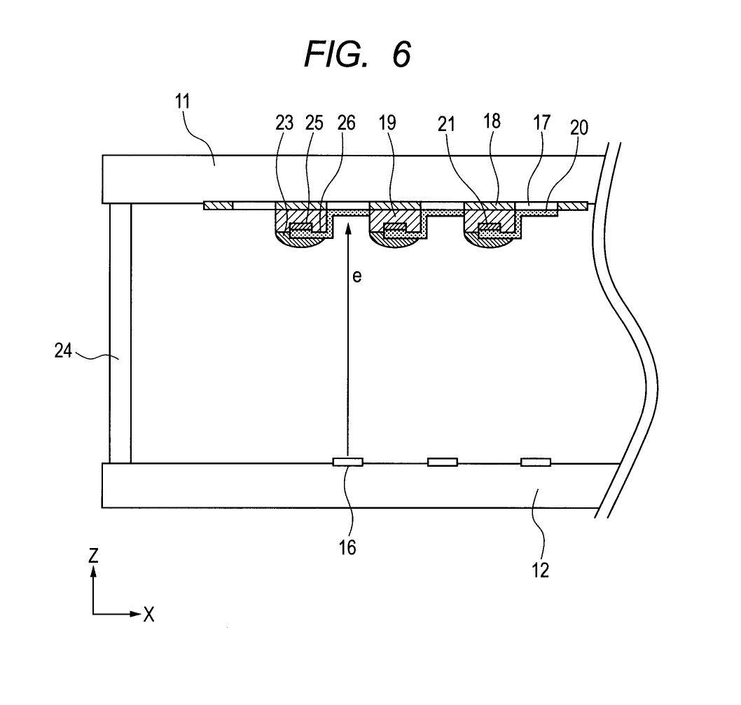

FIGS. 5 and 6 illustrate an image display apparatus according to another example of the present invention. FIG. 5 is a sectional view along line A-A′ of FIG. 1. FIG. 6 is a sectional view along line B-B′ of FIG. 1. The present embodiment in FIGS. 5 and 6 differ in the shape of the partitioning member 19 from the first embodiment in FIGS. 3 and 4 respectively. The surface of the partitioning member 19 facing the rear plate 12 includes a groove 25 along the partitioning member 19. The first resistance member 21 is disposed in the groove 25. The structure can suppress deformation of the first resistance member 21 due to a pressure from the spacer 13, can prevent disconnection of the first resistance member 21, and can prevent image display defects such as a line defect.

Now, specific examples of each component member will be described in detail. The material of the substrate forming the face plate 11 for use in the present invention is not particularly limited, but may include commonly used soda-lime glass, annealed soda-lime glass or high strain point glass.

The face plate 11 has a light blocking member 18 located on a surface of the substrate. Examples of the light blocking member 18 may include a well-known black matrix structure such as for use in a CRT. The material of the light blocking member 18 may generally include black metal, black metal oxide, or carbon. Examples of the black metal oxide may include ruthenium oxide, chromic oxide, iron oxide, nickel oxide, molybdenum oxide, cobalt oxide and copper oxide.

The material of the partitioning member 19 may include an inorganic mixture having a volume resistivity near that of an insulator such as a glass material containing metal oxide such as lead oxide, zinc oxide, bismuth oxide, boron oxide, aluminum oxide, silicon oxide and titanium oxide. The patterning method of the partitioning member 19 may include a sandblasting method, a photosensitive paste applying method and an etching method. Note that the height of the partitioning member 19 may be appropriately set according to the specifications of the image display apparatus 100.

Further, the photosensitive paste applying method may be used to form a groove 25 along the partitioning member 19 on a surface of the partitioning member 19 facing the rear plate 12. In order to form the groove 25, a mask portion with a width of 5 to 20 μm needs to be formed in a photomask for use in patterning so as to allow the groove forming portion to be unexposed. The use of the photomask to expose the photosensitive paste formed as the partitioning member 19 allows an unexposed portion to be formed on the surface of the partitioning member 19 and the inside portion thereof to be exposed. Then, the unexposed portion can be subjected to development to form the groove 25.

The material of the light emitting member 17 may include a phosphor crystal emitting light using an electron beam as the excitation source. Specific materials of the phosphor may include a phosphor material for use in a CRT as described in the “Phosphor Handbook” compiled by Keikoutaidougakukai (Phosphor Research Society) and published by Ohmsha Ltd. A phosphor-dispersed paste can be coated, dried, and baked to be used as the light emitting member 17. Subsequently, a solution containing alkali-silicate, namely, a so-called water glass is sprayed and coated on the substrate in a uniform manner as a binding member, and then dried to bond the light emitting member 17 to the substrate.

Examples of the anode 20 may include a metal back made of Al, known for use in a CRT. The patterning method of the anode 20 may include a vapor deposition method through a mask and an etching method.

Examples of the first resistance member 21 may include a resistor comprising a mixture between conductive particles such as ATO-coated titanium oxide particles and glass materials containing metal oxide such as lead oxide, zinc oxide, bismuth oxide, boron oxide, aluminum oxide, silicon oxide and titanium oxide. The first resistance members 21 can have a resistance value of 1 kΩ to 1 MΩ between the mutually adjacent light emitting members 17 (anodes 20) along the Y direction in the drawing. Further, the patterning of the first resistance members 21 may include any method such as a printing method and a coating method by means of a dispenser.

The material of the feeding electrode 22 is not particularly limited as long as the material is conductive such as metal. The resistance value between both ends of the feeding electrode 22 can be 0Ω to 1 kΩ.

The material of the second resistance member 23 may include a mixture of a glass material with metal oxide such as zinc oxide, tin oxide and titanium oxide. The second resistance member 23 can have a volume resistivity of 1 (M Ωm) to 100 (M Ωm).

In order to relax an external force to the second resistance member 23 from the spacer 13, the second resistance member 23 should to have an appropriate flexibility. The flexibility can be achieved by reducing glass content percentage. The flexibility may be achieved in such a manner that a coating paste composition as a precursor of the second resistance member 23 is impregnated with resin particles and the precursor is baked to form a void inside the second resistance member 23. In this case, a less brittle second resistance member 23 can be formed.

Now, the rear plate 12 will be described. FIGS. 1 and 2 illustrate a plurality of electron-emitting devices 16 mounted on an inner surface of the rear plate 12 so as to emit electrons for exciting a plurality of light emitting members 17 to emit light. Suitable examples of the electron-emitting device 16 may include a surface-conduction electron-emitting device. FIGS. 1 and 2 further illustrate a plurality of scanning wirings 14 and a plurality of information wirings 15 mounted on the inner surface of the rear plate 12 so as to supply a drive voltage to each electron-emitting device 16.

The material of the spacer 13 is desirable to conduct a very small amount of current for antistatic purposes and may include a mixture of a conductive member with an insulating material such as glass. The resistance value of the spacer per abutting portion between the spacer 13 and the first resistance member 21 is desirable to be 10¹⁰ to 10¹⁴Ω. Further, in order to control the potential of the spacer 13, the resistance value in the height direction of the spacer 13, namely, in a direction of the face plate 11 facing the rear plate 12 needs to be set higher than the resistance value of the second resistance member 23 in the same direction. Further, the surface of the spacer 13 may be covered with a resistance member.

The image display apparatus 100 is configured such that the spacer 13 is interposed between the face plate 11 and the rear plate 12 as described above and the edge portions of the face plate 11 and the rear plate 12 are bonded through a side wall 24 to form a hermetically sealed container.

The above embodiment has the spacer 13 interposed between the face plate 11 and the rear plate 12, but the spacer 13 may not be required as long as the hermetically sealed container has a strength enough to withstand the atmospheric pressure. Even in the above configuration, the second resistance member 23 can prevent scattering of the first resistance member 21 caused by an intense electric field occurring at least between both places 11 and 12.

### FIRST EXAMPLE

Now, a first example of the present invention will be described. FIG. 3 is a sectional view along line A-A′ of FIG. 1. FIG. 4 is a sectional view along line B-B′ of FIG. 2. The face plate 11 used for the present example was formed in the following steps.

(Step 1: Light Blocking Member Formation)

A black paste (NP-7811M1 manufactured by Noritake Kizai Co., Ltd.,) was printed on an entire surface of a cleaned glass substrate. Subsequently, the black paste was dried at 150° C., exposed to 1000 mJ/cm², developed, and then baked at 580° C. to form a plurality of light blocking members 18 each having an opening portion with a horizontal pitch of 210 μm and a vertical pitch of 630 μm, the opening portion having a size of 150×200 μm and a thickness of 5 μm.

(Step 2: Partitioning Member Formation)

Next, in order to form a partitioning member 19, an insulating paste containing alumina particles with an average particle diameter of about 5 μm added to a borosilicate glass was applied along the center line of the light blocking members 18 with a pixel interval pitch (210 μm) by means of a slit coater. Subsequently, the insulating paste was dried at 95° C., exposed to 300 mJ/cm², developed, and then baked at 580° to form a plurality of stripe-shaped partitioning members 19 each with a thickness of 200 μm and a width of 55 μm.

(Step 3: Light Emitting Member Formation)

Next, as a light emitting member 17, a paste containing dispersed P22 phosphors for use in a CRT field was used to pour and print the phosphors by screen printing according to the stripe-shaped partitioning members 19. In the present example, three color RGB phosphors were applied differently for each stripe so as to make a color display. Each phosphor had a film thickness of 5 μm. Subsequently, the three color phosphors were dried at 110° C. Note that the drying may be performed separately for each color or collectively for all three colors. Further, after being baked at 500°, a water solution containing alkali-silicates acting later as a binding member, namely, a so-called water glass, was sprayed and applied to the phosphors.

(Step 4: Anode Formation)

Next, ethyl cellulose was applied by printing and dried, a space between phosphor powder particles was filled with ethyl cellulose resin, and then an aluminum film was deposited on the phosphors to form anodes 20. In this case, a dry film resist was laminated only on a portion corresponding to a part of the phosphors as the light emitting members 17 and the stripe-shaped partitioning members 19 to pattern the anodes 20. Note that the aluminum film of the anodes 20 had a thickness of 100 nm.

(Step 5: First Resistance Member Formation)

Next, a plurality of first resistance members 21 were formed in such a manner that a conductive glass paste with a volume resistivity of 0.5 (Ωm) (NP-7840J manufactured by Noritake Kizai Co., Ltd.,) was printed on the top portions 24 of the partitioning members 19 by a pattern printing plate, dried at 110° C., and baked to form the first resistance members 21 with a width of 10 μm. Note that when the material used as the first resistance members 21 was applied to a test pattern and the resistance value was measured, the sheet resistance was 50 kΩ/sq.

(Step 6: Second Resistance Member Formation)

In order to find the conditions for creating a material with a desired volume resistivity, the following work was performed. First, zinc oxide and glass frit were mixed to form a paste. Then, the paste was applied on a test pattern, dried at 110° C., and baked at 500° C., and then the volume resistivity was measured by means of a product name: Hiresta-UP-MCP-HT450 (manufactured by Mitsubishi Chemical Analytech Co., Ltd.). The mixing ratio between the zinc oxide and the glass frit was changed until a volume resistivity of 1 M (Ωm) was obtained.

Next, a plurality of second resistance members 23 were formed in such a manner that a paste having a predetermined mixing ratio was printed on the partitioning members 19 so as to cover the entire first resistance members 21, dried at 110° C., and baked at 500° C. so that the total thickness of the first resistance members 21 and the second resistance members 23 was 20 μm. Thus, the face plate 11 was formed.

In order to verify the volume resistivity of the second resistance members 23, a sample for measuring the volume resistivity was formed under the same conditions. The formed second resistance members 23 were removed from the face plate 11, and crushed, and then the volume resistivity was measured by means of a powder resistivity meter (product name: MCP-PD51 manufactured by Mitsubishi Chemical Analytech Co., Ltd.). As a result, the volume resistivity of the second resistance members 23 was 1 M (Ωm).

(Step 7: Image Display Apparatus Formation)

The image display apparatus 100 illustrated in FIG. 1 was formed such that the spacer 13 was interposed between the face plate 11 and the rear plate 12 as described above and a peripheral portion was hermetically sealed into the edge portions of the face plate 11 and the rear plate 12 through the side wall 24. As illustrated in FIG. 3, the spacer 13 abutted against the second resistance members 23 on the partitioning members 19.

The spacer 13 is desirable to be a high resistance member (third resistance member) conducting a very small amount of current for antistatic purposes. Further, since the spacer 13 abuts against the second resistance members 23, the resistance value in the height direction (Z direction) of the spacer 13 needs to be higher than the resistance value in the film thickness direction (Z direction) of the second resistance members 23. Thus, the spacer 13 can be controlled to a desired potential.

In the present example, the resistance value per abutting portion between the spacer 13 and the second resistance members 23 was such that the spacer 13 was 10¹⁰Ω, and the second resistance members 23 were 4×10⁹Ω.

(Evaluation of Image Display Apparatus)

As thus formed, an image was displayed on the image display apparatus 100 by applying a voltage of 10 kV to the anodes 20 through the feeding electrode 22. As a result, a sufficient luminance intensity was obtained and an excellent image was displayed free from a dark point defect caused by a short-circuit between the cathode and the gate. There was no abnormal discharging due to spacer charging.

### SECOND EXAMPLE

Now, a second example of the present invention will be described. FIG. 5 is a sectional view along line A-A′ of FIG. 1. FIG. 6 is a sectional view along line B-B′ of FIG. 2. The second example differs from the first example in that the partitioning members 19 have a groove 25 and the groove 25 includes the first resistance members 21 in side thereof.

The steps 1 and 3 to 7 are the same as those in the first example. Thus, the following description will focus on the step 2 different from that in the first example.

(Step 2: Partitioning Member Formation)

First, an insulating paste containing alumina particles with an average particle diameter of about 5 μm added to a borosilicate glass was applied in a stripe form along the center line of the light blocking members 18 with a pixel interval pitch (210 μm) by means of a slit coater, and dried at 95° C. Then, the insulating paste was exposed to 300 mJ/cm² using a photomask including stripe-shaped portions each with a line width of 15 μm along the center of each partitioning member 19. Subsequently, the insulating paste was developed and baked at 580° C. to form stripe-shaped partitioning members 19 with a thickness of 200 μm and a width of 55 μm containing a groove 25 with a width of 30 μm and a depth of 20 μm.

In the above steps, the image display apparatus 100 including the face plate 11 illustrated in FIG. 5 was formed.

(Evaluation of Image Display Apparatus)

The same evaluation as in the first example was performed in the present example. As a result, the similar results to that in the first example were obtained.

### FIRST COMPARATIVE EXAMPLE

Now, a first comparative example of the present invention will be described. The first comparative example differs from the first example in that the second resistance members 23 had a volume resistivity of 100 k (Ωm). In order to form such a member, the content percentage of the glass frit contained in the second resistance members 23 described in the first example was reduced. The image display apparatus was formed under the same conditions as in the first example except the above.

(Evaluation of Image Display Apparatus)

As thus described, ten image display apparatuses were formed and an image was displayed for evaluation by applying a voltage of 10 kV to the anodes 20 through the feeding electrode 22 in the same manner as in the first example. As a result, each of the nine image display apparatuses provided sufficient luminance intensity and displayed an excellent image free from a dark point defect caused by a short-circuit between the cathode and the gate, and one image display apparatus had a dark point defect caused by a short-circuit between the cathode and the gate.

In contrast to this, in the configuration of the first example, all the 20 image display apparatuses displayed an excellent image free from a dark point defect caused by a short-circuit between the cathode and the gate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-182286, filed Aug. 17, 2010, which is hereby incorporated by reference herein in its entirety.

What is claimed is:

1. An image display apparatus comprising:
a rear plate provided with a plurality of electron-emitting devices emitting an electron;
a face plate arranged in opposition to the rear plate, wherein the face plate is provided with a plurality of light emitting members being arranged within an image display region displaying an image and emitting light responsive to an irradiation with the electron, an anode arranged over the light emitting member, a partitioning member arranged between the light emitting members adjacent to each other and being shaped protruding toward the rear plate beyond the light emitting member, and a first resistance member being arranged on a portion of the partitioning member opposing the rear plate and being electrically connected to the anode, and wherein
the image display apparatus further comprises a second resistance member covering the first resistance member so that the first resistance member is not exposed within the image display region, and a volume resistivity of the second resistance member is larger than a volume resistivity of the first resistance member
wherein the partitioning member has a groove formed in the portion of the partitioning member opposing the rear plate, and the second resistance member is formed in the groove.

2. The image display apparatus according to claim 1, wherein
the volume resistivity of the second resistance member is 1 M Ωm or more.

3. The image display apparatus according to claim 1, further comprising
a third resistance member arranged between the face plate and the rear plate, wherein the third resistance member contacts the second resistance member, a resistance of the third resistance member in a direction along which the face plate and the rear plate are opposed to each other is larger than a resistance of the second resistance member between the face plate and the rear plate in the direction along which the face plate and the rear plate are opposed to each other.

4. The image display apparatus according to claim 3, wherein
the second resistance member has flexibility to relax the external force to the second resistance member from the third resistance member.

5. The image display apparatus according to claim 4, wherein
the second resistance member includes a void therein.
